(19) United States
(12) Patent Application Publication
(10) Pub. No.: US 2014/0048420 A1
(43) Pub. Date: Feb. 20, 2014

(54) METHOD FOR FABRICATING ONE-DIMENSIONAL METALLIC NANOSTRUCTURES

(71) Applicant: NATIONAL CHIAO TUNG UNIVERSITY, Hsinchu City (TW)

(72) Inventors: Yu-Liang CHEN, Kaohsiung City (TW); Nai-Ying CHIEN, Taichung City (TW); Hsin-Tien CHIU, Taipei City (TW); Chi-Young LEE, Hsinchu County (TW)

(73) Assignee: NATIONAL CHIAO TUNG UNIVERSITY, Hsinchu City (TW)

(21) Appl. No.: 13/660,796

(22) Filed: Oct. 25, 2012

(30) Foreign Application Priority Data
Aug. 17, 2012 (TW) 101129875

(51) Int. Cl. C23C 28/02; C25D 7/12; C25D 5/56; C25D 5/54; B82Y 99/00; B82Y 40/00

(52) U.S. Cl. 205/157; 205/183; 205/165; 205/159; 205/163; 205/186; 977/890; 977/762

(57) ABSTRACT

A method for fabricating one-dimensional metallic nanostructures comprises steps: sputtering a conductive film on a flexible substrate to form a conductive substrate; placing the conductive substrate in an electrolytic solution, and undertaking electrochemical deposition to form one-dimensional metallic nanostructures corresponding to the conductive film on the conductive substrate. The method fabricates high-surface-area one-dimensional metallic nanostructures on a flexible substrate, exempted from the high price of the photolithographic method, the complicated process of the hard template method, the varied characteristic and non-uniform coating of the seed-mediated growth method.

### BACKGROUND OF THE INVENTION

1. Field of the Invention

The present invention relates to a one-dimensional metallic nanostructure, particularly to a method using an electroplating process to form one-dimensional metallic nanostructures on a flexible substrate.

2. Description of the Related Art

To miniaturize various products, the electronics has progressed from the micron age to the nano age. There have been various nanomaterials, including metallic nanomaterials, semiconductor nanomaterials, ceramic nanomaterials, and polymeric nanomaterials. According to their geometrical attributes, nanomaterials may be categorized into zero-dimensional nanomaterials, one-dimensional nanomaterials, two-dimensional nanomaterials, etc. The up-to-date methods for growing a nanostructure on a substrate include the photolithographic method, the hard template method, the seed-mediated growth method and the de-alloy method.

In the photolithographic method, a photoresist material is coated on a substrate. Parallel light from a light source passes through a mask and projects on the photoresist material to duplicate a pattern from the mask to the photoresist material, which is the so-called exposure. After exposure, the photoresist is developed to reveal the pattern. Then, the photoresist is removed to obtain the desired nanowire structure. However, the method needs expensive equipment and uses a complicated process. Besides, the width of the nanowire is limited by the wavelength of the laser light.

The hard template method uses a polymeric material, a porous template or a biomaterial as the template for growing a special metallic nanostructure. The template is placed on a substrate, and a metallic material is deposited on the template with an electrodeposition method, a PVD (Physical Vapor Deposition) method, or a solution reduction method. Then, the template is removed to obtain a metallic nanostructure. The metallic nanostructure fabricated by the method is likely to have many tumbling defects. The size of the nanostructure is limited by the pore size or line width of the template. Besides, the method needs to fabricate a template beforehand and thus has a very complicated process.

The seed-mediated growth method is a liquid-phase synthesis method using a solution containing a reducing agent and a surfactant. The surfactant is a key factor in the liquid-phase method, not only preventing metallic nanoparticles from agglomeration or precipitation but also facilitating the anisotropic growth of the metallic nanoparticles. The surfactant molecules have a hydrophilic terminal and a hydrophobic terminal and are likely to self-assemble to form micelles having various shapes. The micelles may function as templates to form nanostructures having a special geometrical shape. However, the method has a low yield in process scale-up. Besides, the nanostructures fabricated by the method are in form of powder. While the nanostructures are intended to apply to a substrate, the powder must be mixed with some agents to form a paste. Then, the paste is coated on the substrate. However, the mixing-coating process may vary the characteristic of the nanostructures. Besides, the uniformity of the mixing-coating process may affect the performance of the nanostructures.

Accordingly, the present invention proposes a method for fabricating a one-dimensional metallic nanostructure to overcome the abovementioned problems.

### SUMMARY OF THE INVENTION

The primary objective of the present invention is to provide a method for fabricating one-dimensional metallic nanostructures, which uses a simple DC or AC electroplating system to form flexible, high-density and high-surface-area one-dimensional metallic nanowire structures on a flexible substrate, whereby is greatly reduced the fabrication cost and expanded the industrial application thereof.

Another objective of the present invention is to provide a method for fabricating one-dimensional metallic nanostructures, which uses an electroplating method to fabricate one-dimensional metallic nanostructures, whereby are exempted from the high price of the photolithographic method, the complicated process of the hard template method, the varied characteristic and non-uniform coating of the seed-mediated growth method.

A further objective of the present invention is to provide a method for fabricating one-dimensional metallic nanostructures, which favors process scale-up and applies to fabricating electrodes of supercapacitors, lithium batteries, fuel cells, bio testers, electro-luminous elements, etc.

In order to achieve the abovementioned objectives, the present invention proposes a method for fabricating one-dimensional metallic nanostructures, which comprises steps: providing a flexible substrate; sputtering a conductive film on the flexible substrate to form a conductive substrate; placing the conductive substrate in an electrolytic solution, and undertaking electrochemical deposition to form one-dimensional metallic nanostructures corresponding to the conductive film on the conductive substrate.

Below, embodiments are described in detail to make easily understood the objectives, technical contents, characteristics and accomplishments of the present invention.

### BRIEF DESCRIPTION OF THE DRAWINGS

FIG. 1 shows a flowchart of a method for fabricating one-dimensional metallic nanostructures according to one embodiment of the present invention;

FIG. 2 schematically shows one-dimensional metallic nanostructures fabricated according to one embodiment of the present invention;

FIG. 3 schematically shows one-dimensional metallic nanostructures fabricated according to another embodiment of the present invention;

FIGS. 4A-4C show SEM images of one-dimensional gold nanostructures fabricated according to embodiments of the present invention; and

FIG. 5A and FIG. 5B show SEM images of one-dimensional silver nanostructures fabricated according to embodiments of the present invention.

### DETAILED DESCRIPTION OF THE INVENTION

Nanomaterials have superior performance and have been applied to various fields. Among nanomaterials, one-dimensional metallic nanostructures challenge researchers most severely and have the largest space to develop. The current technologies for fabricating one-dimensional metallic nanostructures suffer from high fabrication cost, harsh technical difficulties, and rare technical breakthroughs. Therefore, the present invention proposes a novel method for fabricating one-dimensional metallic nanostructures to overcome the problems of the conventional technologies.

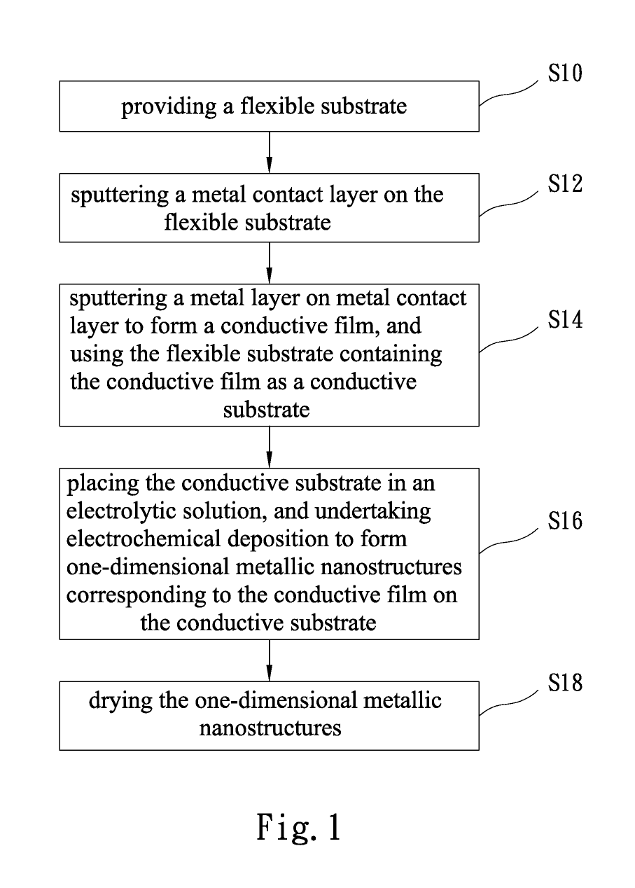

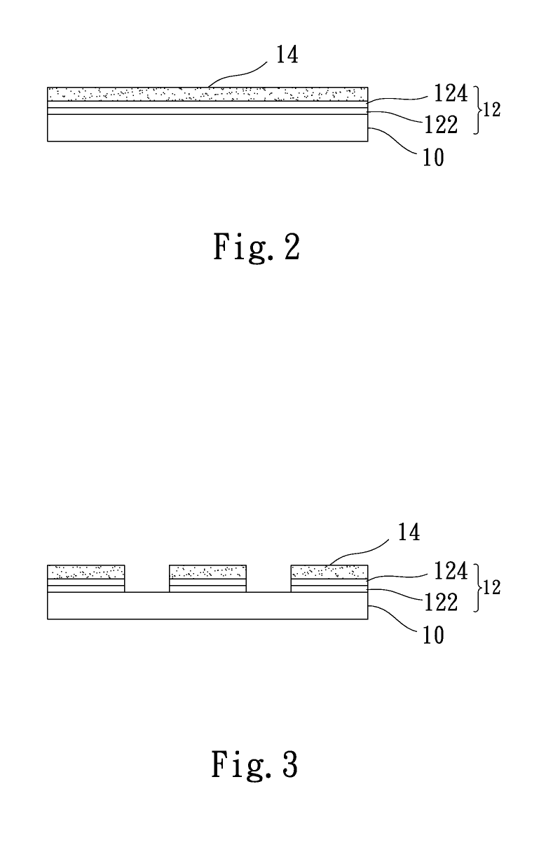

Refer to FIG. 1 showing a flowchart of a method for fabricating one-dimensional metallic nanostructures according to one embodiment of the present invention. Also refer to FIG. 2 a diagram schematically showing one-dimensional metallic nanostructures fabricated according to one embodiment of the present invention. In Step S10, provide a flexible substrate 10, such as a plastic substrate (e.g. a PET substrate), a conductive carbon substrate, a glass substrate, a silicon substrate, or a stainless steel substrate. Next, in Step S12, use an E-gun evaporation machine to sputter a metal contact layer 122 on the flexible substrate 10. The metal contact layer 122 is made of a metal able to securely adhere to the flexible substrate 10, such as titanium or chromium. Next, in Step S14, sputter a metal layer 124 on metal contact layer 122 to form a conductive film 12. The metal layer 124 is made of gold, platinum, silver, or copper. The flexible substrate 10 containing the conductive film 12 is used as a conductive substrate.

Next, in Step S16, place the conductive substrate in an electrolytic solution, and undertake electrochemical deposition. The electroplating system for the electrochemical deposition is a DC bi-electrode system, a DC tri-electrode system, an AC bi-electrode system, or an AC tri-electrode system. Herein, the DC bi-electrode system is used to exemplify the electroplating system. Firstly, the negative electrode is connected with the metal layer 124 of the conductive substrate, and the positive electrode is connected with one side of the flexile substrate 10 of the conductive substrate, which is opposite to the metal layer 124. Next, the electrodes and the conductive substrate are placed in an electrolytic solution. Next, the bias, temperature and time for electroplating are controlled to form one-dimensional metallic nanostructures 14 corresponding to the conductive film 12 on the conductive substrate. The electrolytic solution contains a metal salt, a conductive agent, and a surfactant. The metal salt is selected from a group consisting of HAuCl₄, AgNO₃, and CuCl₂. The conductive agent is NaNO₃. The surfactant is CTAC (cetyl trimethyl ammonium chloride) or CTAB (cetyl trimethyl ammonium bromide). The one-dimensional metallic nanostructures 14 are gold nanowires, silver nanowires, copper nanowires, or platinum nanowires. Next, in Step S18, dry the one-dimensional metallic nanostructures 14 with a dryer, such as a nitrogen blower. Thus is formed on the conductive substrate a whole layer of the one-dimensional metallic nanostructures 14 having high surface area and high electric conductivity.

Refer to FIG. 3. In one embodiment, the conductive film 12 is a patterned conductive film in Step S14. The pattern is formed on the conductive film 12 according to the designed geometrical nanopattern, such as a strip-like nanopattern. The flexible substrate 10 containing the patterned conductive film 12 is used as the conductive substrate. Then are undertaken Steps S16 and S18 to form one-dimensional metallic nanostructures 14 corresponding to the patterned conductive film 12. Therefore, the present invention can fabricate one-dimensional metallic nanostructures 14 with the simplest process.

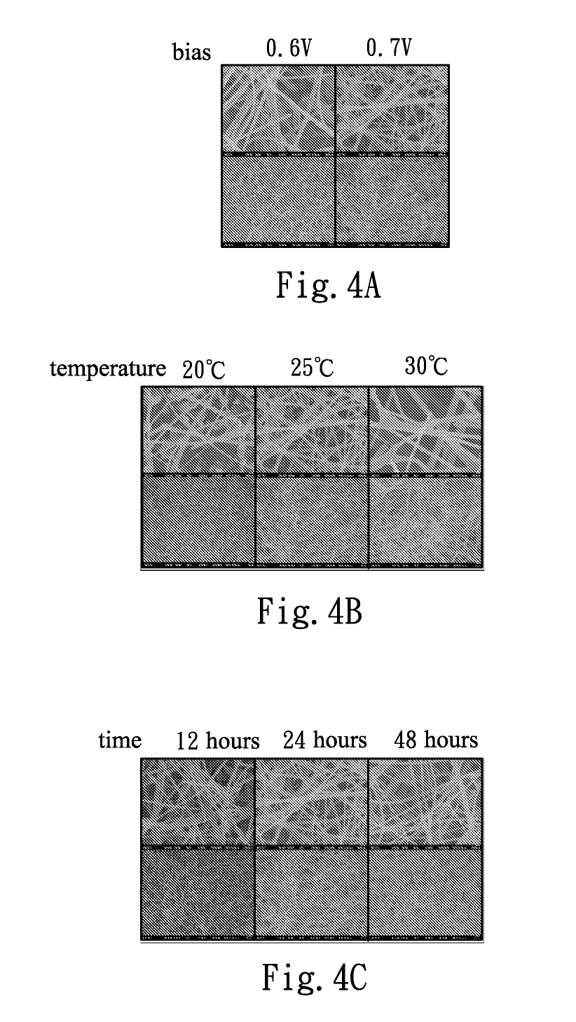

One-dimensional nanostructures of different metals are fabricated with different electrolytic solutions and different fabrication conditions. Herein, the method of the present invention is exemplified with the process for fabricating one-dimensional gold nanostructures. Refer to FIGS. 4A-4C for SEM images of one-dimensional gold nanostructures fabricated according to embodiments of the present invention. The electrolytic solution for fabricating one-dimensional gold nanostructures contains HAuCl₄ (aq), NaNO₃ (aq) and CTAC (aq) by a ratio of from 1:2:2 to 1:4:2, preferably by a ratio of 1:4:2. In one embodiment, the electrolytic solution contains 5 mM HAuCl₄ (aq), 20 mM NaNO₃ (aq) and 10 mM CTAC (aq). In these embodiments, CTAC (aq) adheres to the unstable crystal planes having high energy and functions to inhibit growth of these crystal planes; NaNO₃ (aq) is a conductive agent and also function to inhibit growth of crystal planes and favor isotropic growth of the metallic nanostructures; HAuCl₄ (aq), together with the gold atoms in the metal layer, takes part in an electrochemical reaction. The conductive substrate is placed in the formulated electrolytic solution to undertake electrochemical deposition according the conditions: a bias of 0.6-0.75V, a temperature of 20-30° C., and a time interval of 12-48 hours. The bias of 0.6-0.75V, preferably 0.7V, can control the metallic nanowires to grow along a specified crystal plane, as shown in FIG. 4A. The temperature determines the reaction velocity. Therefore, the temperature directly influences the width and length of the metallic nanowires. As shown in FIG. 4B, while the electroplating is undertaken at a temperature of 20° C. or 30° C., the widths and lengths of the metallic nanowires are less consistent; while the electroplating is undertaken at a temperature of 25° C., the widths and lengths of the metallic nanowires are more consistent. Therefore, the temperature of 25° C. is preferable for the electrochemical deposition of the present invention. As shown in FIG. 4C, the electroplating undertaken for 12-48 hours, preferably for 24 hours, can obtain high-density metallic nanowires. Therefore, the method of the present invention can use the abovementioned electrolytic solution and fabrication conditions to undertake electrochemical deposition and obtain the one-dimensional gold nanostructures 14.

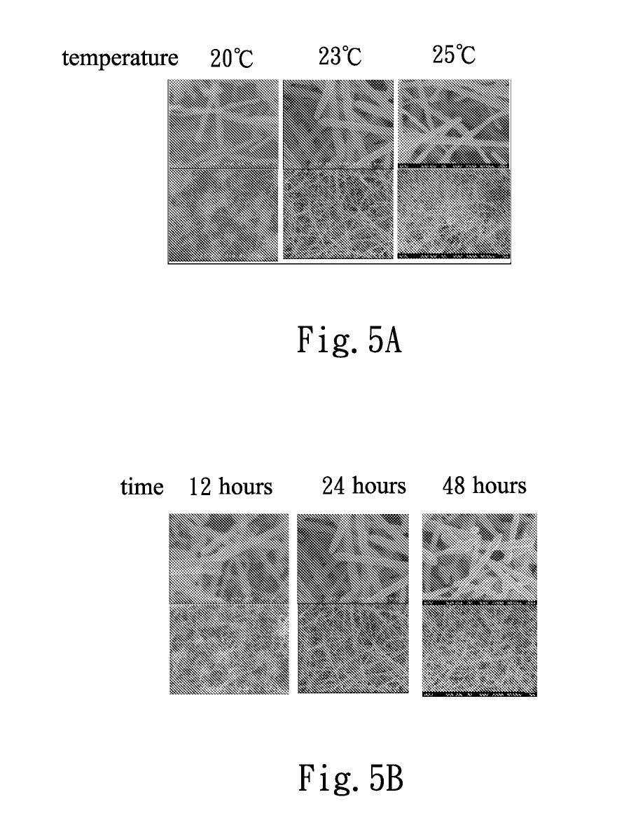

Refer to FIG. 5A and FIG. 5B for SEM images of one-dimensional silver nanostructures fabricated according to embodiments of the present invention. Herein, the method of the present invention is further exemplified with the process for fabricating one-dimensional silver nanostructures. The electrolytic solution for fabricating one-dimensional silver nanostructures contains 7.5 mM AgNO₃ (aq), 5-15 mM HNO₃ (aq) and 5-6 mM CTAC (aq), preferably contains 7.5 mM AgNO₃ (aq), 5 mM HNO₃ (aq) and 5 mM CTAC (aq). The conductive substrate is placed in the formulated electrolytic solution to undertake electrochemical deposition according the conditions: a bias of 1.25-1.35V, a temperature of 20-25° C., and a time interval of 12-48 hours. The electrochemical deposition is preferably undertaken at a bias of 1.30V, whereby to control the metallic nanowires to grow along a specified crystal plane. As shown in FIG. 5A, the electrochemical deposition is preferably undertaken at a temperature of 23° C. As shown in FIG. 5B, the electrochemical deposition is preferably undertaken for 24 hours, whereby to obtain high-density metallic nanowires. Therefore, the method of the present invention can use the abovementioned electrolytic solution and fabrication conditions to undertake electrochemical deposition and obtain the one-dimensional silver nanostructures 14.

From the analysis of the SEM images of the gold and silver nanostructures are known that the present invention proposes a novel and high-performance method to fabricate one-dimensional metallic nanostructures although it is simple and low-cost. The present invention can obtained the optimized one-dimensional metallic nanostructures in a simple and low-cost way, using the novel formulae of electrolytic solutions and the special fabrication conditions. The present invention can fabricate one-dimensional metallic nanostructures having a width of 20-100 nm and a length of 10-50 μm, which are smaller than and superior to the one-dimensional nanostructures fabricated by the conventional technologies.

In conclusion, the present invention fabricates flexible, high-density and high-surface-area one-dimensional metallic structures on a flexible substrate, using a simple DC or AC electroplating system, which not only reduces the fabrication cost but also has high industry utility. Via using an electroplating method to fabricate one-dimensional metallic nanostructures, the present invention is exempted from the high price of the photolithographic method, the complicated process of the hard template method, the varied characteristic and non-uniform coating of the seed-mediated growth method.

Further, the electroplating-based method of the present invention favors process scale-up and pushes application of the next-generation nanoelectronics. The present invention applies to many products, such as electrodes of supercapacitors, lithium batteries, fuel cells, bio testers, electro-luminous elements, etc. Therefore, the present invention has very high market potential.

The embodiments described above are only to exemplify the present invention but not to limit the scope of the present invention. Any equivalent modification or variation according to the characteristic or spirit of the present invention is to be also included within the scope of the present invention.

What is claimed is:

1. A method for fabricating one-dimensional metallic nanostructures, comprising steps:
providing a flexible substrate;
sputtering a conductive film on said flexible substrate to form a conductive substrate; and
placing said conductive substrate in an electrolytic solution, and undertaking electrochemical deposition to form one-dimensional metallic nanostructures corresponding to said conductive film on said conductive substrate.

2. The method for fabricating one-dimensional metallic nanostructures according to claim 1, wherein said one-dimensional metallic nanostructures are gold nanowires, silver nanowires, copper nanowires, or platinum nanowires.

3. The method for fabricating one-dimensional metallic nanostructures according to claim 1, wherein said step of sputtering said conductive film further comprises steps:
sputtering a metal contact layer; and
sputtering a metal layer on said metal contact layer to form said conductive film.

4. The method for fabricating one-dimensional metallic nanostructures according to claim 3, wherein said metal contact layer is made of titanium or chromium, and wherein said metal layer is made of gold, platinum, silver or copper.

5. The method for fabricating one-dimensional metallic nanostructures according to claim 1, wherein said electrolytic solution contains a metal salt, a conductive agent, and a surfactant, and wherein said metal salt is selected from a group consisting of HAuCl₄, AgNO₃, and CuCl₂, and wherein said conductive agent is NaNO₃, and wherein said surfactant is CTAC (cetyl trimethyl ammonium chloride) or CTAB (cetyl trimethyl ammonium bromide).

6. The method for fabricating one-dimensional metallic nanostructures according to claim 2, wherein while said one-dimensional metallic nanostructures are gold nanowires, said electrolytic solution contains HAuCl₄ (aq), NaNO₃ (aq) and CTAC (cetyl trimethyl ammonium chloride) (aq) by a ratio of from 1:2:2 to 1:4:2.

7. The method for fabricating one-dimensional metallic nanostructures according to claim 6, wherein said electrochemical deposition is undertaken at a bias of 0.6-0.75V and a temperature of 20-30° C. for 12-48 hours.

8. The method for fabricating one-dimensional metallic nanostructures according to claim 2, wherein while said one-dimensional metallic nanostructures are silver nanowires, said electrolytic solution contains 7.5 mM AgNO₃ (aq), 5-15 mM HNO₃ (aq) and 5-6 mM CTAC (cetyl trimethyl ammonium chloride) (aq).

9. The method for fabricating one-dimensional metallic nanostructures according to claim 8, wherein said electrochemical deposition is undertaken at a bias of 1.25-1.35V and a temperature of 20-25° C. for 12-48 hours.

10. The method for fabricating one-dimensional metallic nanostructures according to claim 1, wherein said electrochemical deposition is a DC bi-electrode system, a DC tri-electrode system, an AC bi-electrode system, or an AC tri-electrode system.

11. The method for fabricating one-dimensional metallic nanostructures according to claim 1, wherein said flexible substrate is a plastic substrate, a conductive carbon substrate, a glass substrate, a silicon substrate, or a stainless steel substrate.

12. The method for fabricating one-dimensional metallic nanostructures according to claim 1, wherein said one-dimensional metallic nanostructures having a width of 20-100 nm and a length of 10-50 μm.

13. The method for fabricating one-dimensional metallic nanostructures according to claim 1 further comprising a step of drying said one-dimensional metallic nanostructures after said electrochemical deposition.

14. The method for fabricating one-dimensional metallic nanostructures according to claim 13, wherein in said step of drying said one-dimensional metallic nanostructures, a nitrogen blower is used to dry said one-dimensional metallic nanostructures.

15. The method for fabricating one-dimensional metallic nanostructures according to claim 1, wherein said conductive film is a patterned conductive film.
